(19) United States
(12) Patent Application Publication
(10) Pub. No.: US 2025/0322025 A1
(43) Pub. Date: Oct. 16, 2025

(54) Method of Analyzing a Web Page Gap Based on Examination of Information in the Web Page

(71) Applicant: Spy Fu, Inc., Scottsdale, AZ (US)

(72) Inventor: Michael Roberts, Scottsdale, AZ (US)

(73) Assignee: Spy Fu, Inc., Scottsdale, AZ (US)

(21) Appl. No.: 19/174,217

(22) Filed: Apr. 9, 2025

Related U.S. Application Data
(60) Provisional application No. 63/632,445, filed on Apr. 10, 2024.

(51) Int. Cl. G06F 16/958; G06F 16/953; G06F 40/30

(52) U.S. Cl. CPC G06F 16/958; G06F 16/953; G06F 40/30

(57) ABSTRACT

A method for assisting web page authors to create more comprehensive content, which in turn increases the search engine optimization ranking of the web page by utilizing available artificial intelligence engines to analyze the information gaps between the author's existing content and other related existing content located on the internet.

This application claims the benefit of pending U.S. Provisional Application 63/632,445 filed on Apr. 10, 2014.

### FIELD OF THE INVENTION

The present invention generally relates to assisting web page authors to create more comprehensive content by utilizing available artificial intelligence engines to analyze the information gaps between the author's existing content and other related content on the internet. This invention is advantageous to authors who want their content to obtain the highest ranking on search engines such as Google because search engines rank websites higher if the content includes more thorough information. Variations of the preferred embodiment are also provided.

### BACKGROUND

Most owners of website content that exists on the internet desire to maximize the exposure and accessibility of their content. Some forms of exposure come from advertising the top-level domain name using traditional methods such as radio, television, word-of-mouth, newspaper, flyer, leaflet, pamphlet, and word-of-mouth advertising. More recently, website owners rely on keyword advertising on the most pervasive internet search engines such as Google® or Bing®. Keyword advertising is a type of online advertising where an advertiser pays to have an ad appear in search engine results when someone uses a particular phrase to search the web. Advertisers identify keywords that they believe best fit their advertising campaign and then bid on these terms. If a potential customer clicks on an ad and is redirected to a website page, the advertiser pays per click to the website. For example, if you sell footwear, you can make sure people searching for keywords like “sneakers” or “women's boots” see your advertisements.

Search Engine Optimization (SEO) is the process of making a website appear in search results pages. SEO works by using several techniques, such as optimizing content, conducting keyword research, earning inbound links, analyzing content to determine if it would be relevant for a search query, and shaping a website according to the search engine's algorithm. The higher a website is listed, the more people will see it. And a higher listing can lead to more traffic and sales for the business.

In order to improve a website's ranking in search results, a search engine may consider factors like the user's location and language and the words they searched. For example, Google crawls the web, looking for new or updated web pages. It discovers URLs by following links, reading sitemaps, and many other means. Technical SEO optimizations are done on the back end of a website to make sure it meets Google's site security and user experience requirements.

The current state of the art for creating websites involves individuals (or machines) writing original content that does not include a sufficient amount of pertinent material to rank optimally in search engines for a given search. Furthermore, it is not clear to the author what material may be lacking that higher ranking webpages have. The current method enables content creators to write more comprehensive content by analyzing the gaps between an existing piece of their content and other content.

The present invention solves the problem of providing sufficient content for a first website to maximize its SEO ranking by utilizing a method that uses large language models (LLMs) to examine the universe of websites, locating at least one website that contains topics similar to the first website by analyzing the content of the universe of websites, analyzing the content of similar websites and comparing it to the content of the first website, determining any questions that the first website and the similar websites answer about the topics, determining which questions the similar websites answer more thoroughly than the first website, and determining questions that the similar websites answer that the first website does not answer.

The resulting information created from the examination of the websites and the answers provided from the questions answered is then inserted into the first website in the appropriate locations. Doing so can achieve greater SEO optimization and a higher SEO ranking.

### BRIEF DESCRIPTION OF THE DRAWINGS

A more complete understanding of the present invention may be derived by referring to the detailed description and claims when considered in connection with the following illustrative figures, like reference numbers, referring to similar elements and steps throughout the figures.

FIG. 1 illustrates a flowchart that shows the steps in comparing the content of a first and second websites, determining what questions each of the first and second websites answer, and comparing the content of the answers.

FIG. 2 illustrates a flowchart that shows the steps in the method when the answer to a question in the content from the first website is equivalent to the answer to a question from the content in the second website.

FIG. 3 illustrates a flowchart that shows the steps in the method when the answer to a question is included in the content of the second website is not included in the content of the first website.

FIG. 4 illustrates a flowchart that shows the steps in the method when the answer to a question is included in the content of the second website, but the answer to the question is only partially included in the content of the first website.

### DESCRIPTION OF PREFERRED EMBODIMENT

The following are descriptions of a preferred embodiment and variations of the preferred embodiment of the invention.

In the following description, and for the purpose of explanation, numerous specific details are provided to thoroughly understand the various aspects of the invention. It will be understood, however, by those skilled in the relevant arts that the present invention may be practiced without these specific details. In other instances, known structures and devices are generally shown or discussed to avoid obscuring the invention. In many cases, a description of the operation is sufficient to enable one to implement the various forms of the invention, mainly when the operation is to be implemented in software. It should be noted that there are many alternative configurations, devices, and technologies to which the disclosed embodiments may be applied. The full scope of the invention is not limited to the example(s) described below.

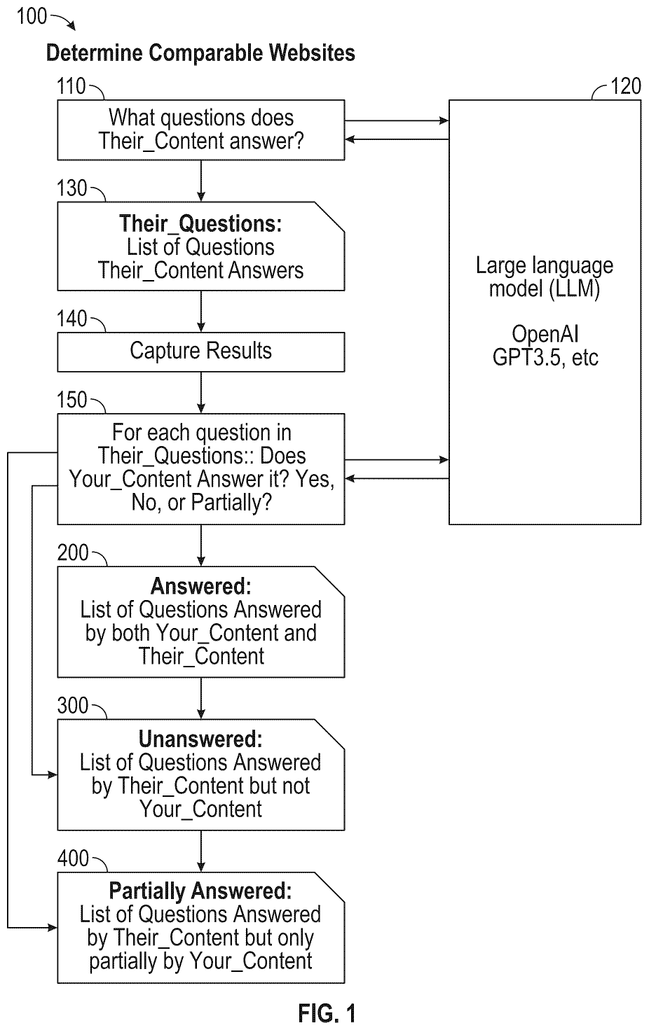

FIG. 1 illustrates the initial steps of the invention. The first step, 100, is to determine a comparable second website with a higher search engine ranking than a first website. Once the second website is identified, the next step, 110, is to utilize a large language model (“LLM”) 120 to determine a question or a plurality of questions that the content of the second website answers. The next step 130 is to examine the content of the second website and determine whether the content of the second website and any of its sub-pages answer the question or the plurality of questions. The next step 140 is to capture the inquiry results, which include the question or plurality of questions returned from the LLM.

The next step, 130, is to examine the question or each of the plurality of questions from the inquiry results returned from the LLM 120. For a first question, step 150 is an inquiry into the LLM 120 to determine whether the content of the first website answers the first question equivalently 200, not at all 300, or partially 400. If more than the first question is present, then these steps are repeated for each of the remaining plurality of questions.

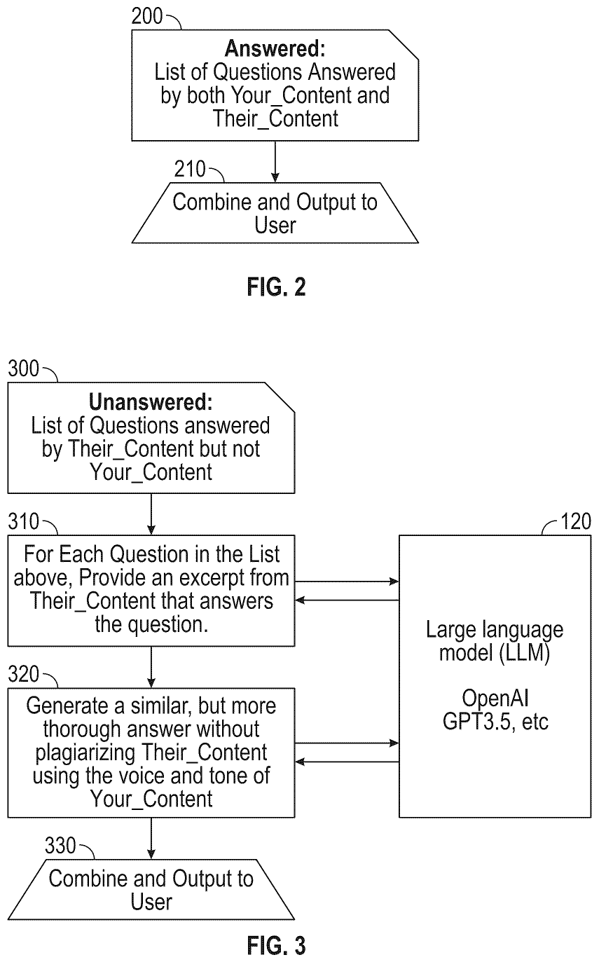

FIG. 2 illustrates step 200, which occurs if the results of the inquiry from step 150 into the LLM 120 are that the first website and the second website answered the first question equivalently. When the first and second websites provide the same answer to the first question, the next step 210 is to combine the content from the answers provided from the first and second websites to the first question and insert the answers into the content of the first website. No further action is necessary regarding the first question. These steps are repeated for any of the additional plurality of questions if they exist.

FIG. 3 illustrates step 300, which occurs when the results of the inquiry from step 150 into the LLM 120 are that the second website answers the first question, but the first website does not answer the first question. The first step 310 is to obtain an excerpt from the answer to the first question generated from the LLM 120. The next step 320 is to enter the text of the first question into the LLM 120 and request that it generate a more thorough answer to the first question than the answer that was provided from the content from the second website. The final step, 330, involves capturing the text of the answer that was provided from the content from the second website and inserting it into the content of the first website. These steps are repeated for any of the additional plurality of questions if they exist.

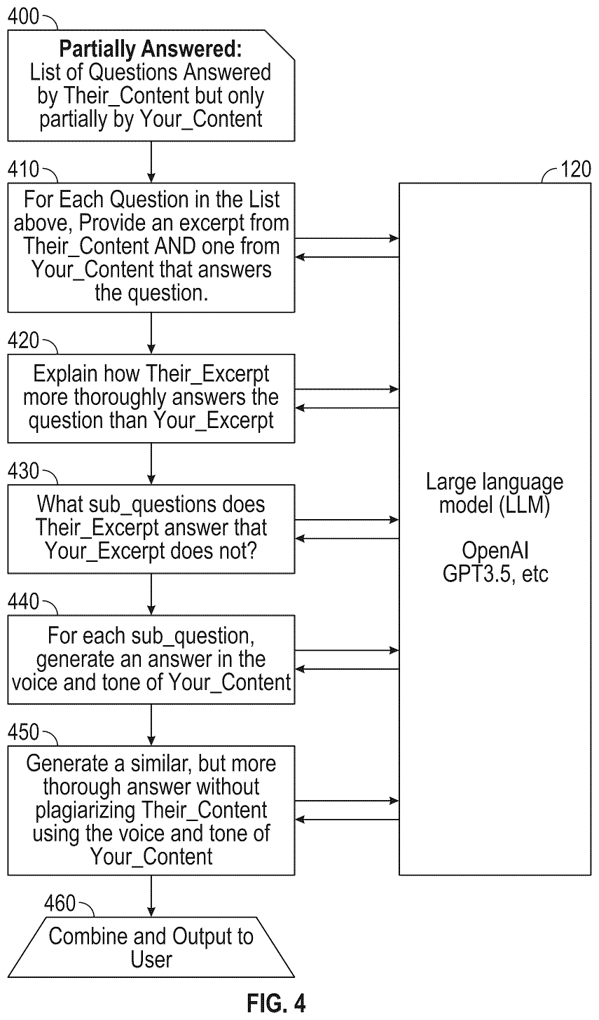

FIG. 4 illustrates step 400, which occurs when the results of the inquiry from step 150 into the LLM 120 are that the content of the second website answers the first questions, but the first website includes content that partially answers the first question. The first step, 410, is to obtain an excerpt from the content of the respective answers to the first question from the second website and from the content of the answer to the first question from the first website. The next step, 420, is to submit the content of each of the respective answers from the first website and the second website to the LLM 120 and inquire as to how the content from the answer to the first question from the second website is a more thorough or accurate result than the content from the answer to the first question from the first website. The next step, 430, is to inquire into the LLM 120 to determine if any sub-questions to the first question exist, and if so, what answers does the content answer to the first question from the second website answer that the content to the answer to the first question from the first website does not answer. The next step, 440, is to submit each sub-question that the LLM 120 generated to the LLM 120 and generate an answer to each sub-question. Alternatively, an inquiry into the LLM 120 can be made to examine the specific tone and style of the content of the first website and request that the LLM 120 generate the answer to each sub-question in the particular manner and style of the content of the first website. The next step, 450, is to request that the LLM 120 generate a similar but more thorough answer to the first question from the first website without copying the answer to the first question of the second website. The final step, 460, is to combine the output answer generated to the first question from the first website with the original content of the first website. These steps are repeated for any of the additional plurality of questions if they exist.

What is claimed is:

1. A method for improving the search engine optimization (SEO) ranking of a first website, comprising the steps of:
A. identifying a second website having a higher SEO ranking than the first website;
B. utilizing a large language model (LLM) to analyze the content of the second website and determine a plurality of questions answered by the content of the second website;
C. comparing the content of the first website to the content of the second website to determine, for each of the plurality of questions, whether the first website:
i. provides an equivalent answer,
ii. does not answer the question, or
iii. partially answers the question; and
D. generating updated content for the first website based on the results of the comparison between the content of the first website to the content of the second website to improve the SEO ranking.

2. The method of claim 1, wherein the step of determining whether the first website answers a question further comprises the step of querying the LLM using the content of the first website.

3. The method of claim 1, further comprising the step of generating an answer to each unanswered question using the LLM in the tone and style of the first website.

4. The method of claim 1, wherein the updated content further comprises merged excerpts from both the first website and the second website for equivalently answered questions.

5. The method of claim 1, wherein for partially answered questions, a sub-question is identified and answered using the LLM.

6. The method of claim 1, further comprising the step of inserting the updated content into a relevant section of the first website.

7. The method of claim 1, further comprising the step of selecting the LLM from a group comprising a transformer-based language model.

8. The method of claim 1, further comprising the step of identifying the second website on its ranking in a predefined search engine result for a target keyword.

9. The method of claim 1, further comprising the step of storing the plurality of questions and the corresponding classification in a structured database.

10. The method of claim 1, further comprising the step of identifying the second website by examining search engine results for a given keyword.

11. The method of claim 1, further comprising the step of highlighting the difference in content between the first and second websites in a user interface dashboard.

12. A system for enhancing content of a first website using artificial intelligence, comprising:
A. a comparison module configured to identify a second website having a higher SEO ranking than the first website;
B. a query module configured to use a large language model (LLM) to determine a plurality of questions answered by the second website;
C. an analysis module configured to determine whether the first website answers each question by
i. providing an equivalent answer,
ii. not answering the question, or
iii. partially answering the question; and
D. a generation module configured to use the LLM to generate enhanced content to supplement or replace existing content on the first website based on the analysis; and
E. an integration module configured to insert the enhanced content into the first website.

13. The system of claim 12, wherein the generation module is further configured to avoid duplication of content from the second website.

14. The system of claim 12, wherein the analysis module ranks the importance of unanswered or partially answered questions based on relevance or frequency.

15. The system of claim 12, wherein the integration module presents suggested updates to a human author for approval prior to publication.

16. The system of claim 12, wherein the generation module synthesizes additional answers to questions using training data aligned with a target domain of the first website.

17. A non-transitory computer-readable medium storing instructions that, when executed by a processor, cause the processor to:
A. identify a second website with a higher SEO ranking than a first website;
B. analyze the content of the second website using a large language model (LLM) to extract a list of questions answered by the content;
C. compare the questions and corresponding answers from the second website to content on the first website to determine whether the content is equivalent, does not answer the questions, or partially answers the question; and
D. generate enhanced content for the first website, using the LLM, to provide missing information identified during the comparison.

18. The medium of claim 17, wherein the instructions further cause the processor to flag unwanted content on the first website for replacement.

19. The medium of claim 17, wherein the instructions include capturing excerpts from the first and second websites and comparing them using the LLM.

20. The medium of claim 17, wherein the enhanced content is generated by combining a user-defined prompt with the LLM's answer to the identified question.
